(19) United States
(12) Patent Application Publication
(10) Pub. No.: US 2008/0153074 A1
(43) Pub. Date: Jun. 26, 2008

(54) LANGUAGE EVALUATION AND PRONUNCIATION SYSTEMS AND METHODS

(76) Inventor: Andrew Miziniak, Plainsboro, NJ (US)

Correspondence Address: MEREDITH & KEYHANI, PLLC, 330 MADISON AVE., 6TH FLOOR, NEW YORK, NY, 10017, US

(21) Appl. No.: 11/613,382

(22) Filed: Dec. 20, 2006

(51) Int. Cl. G09B 19/10

(52) U.S. Cl. 434/178

(57) ABSTRACT

A method of teaching language instruction, the method comprising the steps of: identifying a sound, where the sound is a portion of a word; associating a hand gesture with the sound; associating a movement of the hand gesture with variations in sound to provide a sound gesture; providing a portion of text to be read by a user; correcting the users pronunciation utilizing the sound gesture.

### BACKGROUND OF THE INVENTION

The present invention relates generally to systems and methods for assessing, evaluating and teaching accent free language skills.

Many people start learning languages in school; they may improve their comprehension by watching television in that language (e.g. English), taking classes and perhaps immersing themselves in the language through either a program or visiting the native country. But even if the English (or other language) learner knows all the grammar rules and understands native speakers, there is no guarantee that they will be understood. Accent can be the biggest obstacle in language instruction. A heavy accent can ruin not only a simple conversation, but may adversely affect the speaker's career. In particular, occupations that require speaking with clients, giving presentations, negotiations, etc., may be entirely impossible to non native speaking individuals. The national and international language exams required for certain positions do not test for accents, therefore the results may be misleading about the actual language ability of the test taker. For example, a non-English speaking individual may be able to pass the bar exam, but may not be able to effectively communicate to a jury. Accordingly, all their hard work in passing this exam may be irrelevant as the accent may prevent their being effective in that position.

It is widely believed that it is extremely difficult for adults to learn a second language. In fact, there have been several studies and experiments to support the critical period hypothesis, according to which full language acquisition is impossible beyond a certain age, most commonly argue, beyond puberty. Although there may be some truth to this hypothesis, recent research has failed to support this. This is to say that even those who begin to learn a language years after puberty are able to learn the language and gain a high level of fluency. The only aspect of language that has been shown to adhere to the critical period hypothesis is accent. Accordingly, the majority of those who start learning a language after puberty will not be able to acquire a native-like accent.

Grammar structure, spelling and conjugation can be acquired through courses and books, and comparing it to your native language. However, when it comes to pronunciation and accent, there is not much practical help, other than to practice hearing and conversing with a native speaker, to learn the phonetic system, or to associate the sound in English to a sound in your native language.

One prior art method of correcting pronunciation and accent is computer software pronunciation workshops. According to this method, language speakers may speak and imitate a native language speaker. For example, the word may be spoken and heard by the student, who then repeats the word. However, such methods are flawed in that they do not provide feedback and fail to consider the individual's background and native language, which should be incorporated into the pronunciation work. If the student can not get a sound, such as an “r”, simply repeating will not sure this problem. They will be able to repeat the word, but they may not be understood.

U.S. Pat. No. 4,609,357 issued to Clegg discloses another method to teach students language. According to this method all alphabetic characters are eliminated and replaced with characters that represent sounded syllables. Such a method is useful in that words are described by symbols according to the way they sound. However, this is very confusing, as students must learn a new language as well as a new set of symbols, which can have a negative effect on their spelling or writing skills as well. Further, this phonetic language translation method focuses on reading, therefore it is not interactive, if a student is mispronouncing the symbol, they will repeatedly mispronounce that symbol. In this way, it would not effectively eliminate their accent.

U.S. Pat. No. 6,869,286 issued to Furry discloses another method of learning language as known in the art. Similar to much of the prior art, the Furry patent provides a set of fictional characters, each character being associated with a predetermined phoneme of a language. This may also include software that is configured to pronounce a selected letter, phoneme or word appearing on display and/or to display a picture representing the word. This method was not designed specifically for English language learners who come from different language backgrounds and need to improve their accents in order to communicate effectively.

While much of the prior art associates images with sounds, there has yet to be an interactive system that evaluates the individuals background, native language and provides interactive feedback of sounds and the speakers pronunciation of these sounds. Accordingly, the present methods and systems teach the speaker to speak fluently with fluidity and confidence and to reduce or eliminated any accent.

### SUMMARY OF THE INVENTION

The present invention relates generally to language evaluation and pronunciation systems and methods.

A method of teaching language instruction, the method comprising the steps of: identifying a sound, where the sound is a portion of a word; associating a hand gesture with the sound; associating a movement of said hand gesture with variations in the sound to provide a sound gesture; providing a portion of text to be read by a user; correcting the users pronunciation utilizing the sound gesture.

A method of evaluating and correcting language instruction, the method comprising the steps of: providing a reading sample for a student; asking the student to read the reading sample aloud; assessing said students ability to pronounce the y sound versus the ee sound and providing a relative score according to the students pronunciation of the y sound; assessing the students ability to pronounce the er sound and providing a relative score according to the students pronunciation of the er sound; assessing the students ability to pronounce the ah sound and providing a relative score according to the students pronunciation of the ah sound; assessing the students ability to pronounce the ae sound and providing a relative score according to the students pronunciation of the ae sound; assessing the students ability to pronounce the o sound and providing a relative score according to the students pronunciation of the o; assessing the students ability to pronounce the th sound and providing a relative score according to the students pronunciation of the th sound; assessing the students ability to pronounce a ugh sound and providing a relative score according to the students pronunciation of the ugh sound; assessing the students ability to pronounce a ch sound versus a j sound and providing a relative score according to the students pronunciation of the ch sound versus the j sound; assessing the students ability to pronounce a w sound versus a v sound and providing a relative score according to the students pronunciation of the w sound versus the v sound; assessing the students ability to pronounce a oogh sound and providing a relative score according to the students pronunciation of the oogh sound; assessing the students ability to pronounce an s sound versus a z sound and providing a relative score according to the students pronunciation of the s sound versus the z sound; and determining a lesson plan according to the relative scores.

A method of evaluating and correcting language instruction, the method comprising the steps of: providing a reading sample for a student; asking the student to read the reading sample aloud; assessing the students ability to pronounce the y sound versus the ee sound and providing a relative score according to the students pronunciation of the y sound; assessing the students ability to pronounce the er sound and providing a relative score according to the students pronunciation of the er sound; assessing the students ability to pronounce the ah sound and providing a relative score according to the students pronunciation of the ah sound; assessing the students ability to pronounce the ae sound and providing a relative score according to the students pronunciation of the ae sound; assessing the students ability to pronounce the o sound and providing a relative score according to the students pronunciation of the o; assessing the students ability to pronounce the th sound and providing a relative score according to the students pronunciation of the th sound; assessing the students ability to pronounce a ugh sound and providing a relative score according to the students pronunciation of the ugh sound; assessing the students ability to pronounce a ch sound versus a j sound and providing a relative score according to the students pronunciation of the ch sound versus the j sound; assessing the students ability to pronounce a w sound versus a v sound and providing a relative score according to the students pronunciation of the w sound versus the v sound; assessing the students ability to pronounce a oogh sound and providing a relative score according to the students pronunciation of the oogh sound; assessing the students ability to pronounce an s sound versus a z sound and providing a relative score according to the students pronunciation of the s sound versus the z sound; determining a lesson plan according to the relative scores and working on those sounds have the lowest relative scores; identifying a sound, where the sound is a portion of a word; associating a hand gesture with the sound; associating a movement of the hand gesture with variations in the sound to provide a sound gesture; identifying a mouth movement; associating a hand gesture with the mouth movement; associating a movement of the hand gesture with the mouth movement to provide a mouth gesture; identifying a phonetic articulation; associating a hand gesture with the phonetic articulation; associating a movement of the hand gesture with the phonetic articulation to provide a phonetic gesture; providing a portion of text to be read by a user; correcting the users pronunciation utilizing the sound gesture; correcting the users mouth movement utilizing the mouth gesture; and correcting the phonetic articulation utilizing the phonetic gesture.

These and other features, aspects and advantages of the present invention will become better understood with reference to the following description and claims.

### BRIEF DESCRIPTION OF THE DRAWINGS

FIG. 1 depicts a hand gesture and movement according to the present invention;

FIG. 2 depicts a hand gesture and movement according to the present invention;

FIG. 3 depicts a hand gesture and movement according to the present invention;

FIG. 4 depicts a hand gesture and movement according to the present invention;

FIG. 5 depicts a hand gesture and movement according to the present invention;

FIG. 6 depicts a hand gesture and movement according to the present invention;

FIG. 7 depicts a hand gesture and movement according to the present invention;

FIG. 8 depicts a hand gesture and movement according to the present invention;

FIG. 9 depicts a hand gesture and movement according to the present invention;

FIG. 10 depicts a hand gesture and movement according to the present invention;

FIG. 11 depicts a hand gesture and movement according to the present invention;

FIG. 12 depicts a hand gesture and movement according to the present invention;

FIG. 13 depicts a hand gesture and movement according to the present invention;

FIG. 14 depicts a hand gesture and movement according to the present invention;

FIG. 15 depicts a hand gesture and movement according to the present invention;

FIG. 16 depicts a hand gesture and movement according to the present invention;

FIG. 17 depicts a hand gesture and movement according to the present invention;

FIG. 18 depicts a hand gesture and movement according to the present invention; and

FIG. 19 depicts a hand gesture and movement according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

It is widely accepted that the English language has become the universal language of the world. The global business landscape, the Internet and Hollywood movies, just to mention a few, have all contributed to increasing need to learn and popularity to speak English.

Many people start learning English in school and depending on the individual situation; they can improve their comprehension by watching English language channels, their grammar by taking private English classes and if they are lucky enough, they may even get the chance to go to an English-speaking country to improve their overall knowledge of the language. But even if the English learner knows all the grammar rules and understands native speakers, there is no guarantee that he/she will actually be understood by them. Accent can be the biggest obstacle in the language learner's journey. A heavy accent can ruin not just a simple conversation but even a career, where the goal is to be understood when talking with clients, giving presentations, negotiating, etc. The national and international language exams required for certain positions do not test accent, therefore its results can be misleading about the actual language ability of the test-taker.

When learning a language, the easiest part is to learn vocabulary, then comes memorizing grammar rules. Putting the two together, students would start translating from their native tongue and hope to be understood. This is the base of the grammar-translation method, which is the typical school approach. The learner will soon start to feel comfortable reading and writing in the target language. Understanding others speaking is the next level of difficulty, especially when it comes to one-on-one interaction with a native speaker. The hardest skill to master of all is speaking, more specifically speaking correctly, which is much more difficult than one would think. Knowing the appropriate grammar rules, vocabulary, nuances of the language by itself does not mean that one would be able to speak it too. It is all “just” theory and it takes months, if not years, of constant practice, self-correction and exposure to the language to master speaking. Unfortunately, though, this is still not the end of the language learning journey. Despite the years of hard work, English learners at this stage can still have trouble communicating with native speakers because of their accent, even when that accent is hardly audible for non-native English speakers.

Most people believe that children are better suited to learn a second language than are adults. In fact, there have been several studies and experiments to support the critical period hypothesis, according to which full language acquisition is impossible beyond a certain age, most commonly argued, beyond puberty. Although there is some truth to this hypothesis, recent second language acquisition research has failed to support it in its strong form. This is to say that even those who begin to learn a language years after their puberty are able to learn the language and gain a high level of fluency. The only aspect of language that has been shown to adhere to the critical period hypothesis is accent. This basically means that the majority of those who start learning a language after puberty, will not be able to acquire a native-like accent.

In order to learn English, one could be raised in an English speaking country, or could take classes and using multi-media methods, to learn the ever-changing structure of the English language. Grammar structure, spelling, and conjugation can be acquired through courses and books, and even by comparing it to your native language. But when it comes to pronunciation, there was not much practical help, other than to practice hearing and conversing with a native speaker, to learn the phonetic system, or to associate the sound in English to a sound in your native language. Many computer software pronunciation workshops can help, but lacks the ability to give immediate feedback, and consideration of the individual's background and native language should be incorporated into the pronunciation work.

The present invention provides such feedback through a specific linguistic metrics system, to correctly evaluate a student's starting point, and what needs to be learned and improved. The premise of present invention is to simplify the students understanding of English pronunciation through the use of a technique that allows the student to locate a sound without the immediate correction by an instructor. Carefully decoding the English pronunciation by order of most often mispronounced words, to form simple rules that are easy to follow lead us to the metrics system of evaluation. Individuals with many years of study and experience in the English language still struggle with being understood clearly, and being able to present the information fluently. Continuous study of grammar and vocabulary is not always the answer to fluidity and fluency. Learning the rules of pronunciation does not eliminate the wrong habits that have been learned through years of practice. Most language schools and English lessons only offer different levels of knowledge of the English language. Very often, English students do not realize their own misinterpretation of the English pronunciation, because of a lack of system to identify the difference between a foreigner and a native speaker's speech.

The point scoring system may be based on a total of 1000 points. Each sound that's significant in the English speech is scored depending on the order of frequency and importance. The initial assessment goes through a thorough evaluation by a trainer, by metrics not by opinion, and is re-evaluated throughout the course, to ensure progress. The evaluation is done as accurately as possible, by digital premise, so either the pronunciation exists, or it doesn't. The basis is whether the student sounds like a native speaker or not, in each specific area of sound.

In order to simplify the rules of English pronunciation, the most frequently used sounds in the English language were calculated, and separated into 11 categories. After counting the most common sound occurrence in English, we started seeing a pattern in the English pronunciation. The students need to perfect these 11 common sounds, in order to sound like a native English speaker. Here are the descriptions of the sounds, and the number of % each occurred in the most 1000 most commonly used words in the English language.

| | | |
|---|---|---|
| 1. | “y” as in the word This | 16.5% |
| 2. | “er” as in the word better | 13% |
| 3. | “ee” as in the word day | 11% |
| 4. | “ugh” as in the word mom | 9% |
| 5. | “ae” as in the word bag | 7% |
| 6. | “o” as in the word gold | 6.6% |
| 7. | “w” as in the word world | 6% |
| 8. | “th” as in the word the | 4% |
| 9. | “S as Z” as in the word says | 4% |
| 10. | “ch” as in the word cheese | 4% |
| 11. | “all” as in the word mall | 2% |

While, there are other sounds that make up the English pronunciation, it is the aim of the present invention to simplify the rules and structure of the curriculum, to narrow it down to a list of most mispronounced, frequent sounds. The rest of the sounds that occur in the reading exercises, will be regarded by the instructor. So often, in the English language, several different spellings occur in the same sound, and this is another facet of the English pronunciation that the student needs to familiarize themselves with. Below is a list of 11 sounds, with different spellings that describes the sounds.

1. “y” this, business, pretty, busy, build, between, question, captain, determine, syllable, experience

2. “er” word, other, picture, earth, answer, fire, temperature, sugar, occur

3. “ee” he, very, mean, need, carry, machine, complete, equal, imagine, valley, ski

4. “ugh” mom, just, country, part, wonder, syllable, garden, caught

5. “ae” and, that, began, camp, atom

6. “o” low, move, shoulder

7. “w” window, twenty, women

8. “th” the, these, thought, together, third, either

9. “S as Z” cause, these, present, season, opposite

10. “ch” try, country, change, trouble, choose, touch

11. “all” all, mall, plural, war, always, natural

Instead of memorizing the rules of spelling and pronunciation, the present invention uses hand gestures to signify the appropriate sound, for the student to acquire the correct sounds through visual notification. After awhile of practice, the student will identify the sound patterns without being particularly hung up on the spelling of each word.

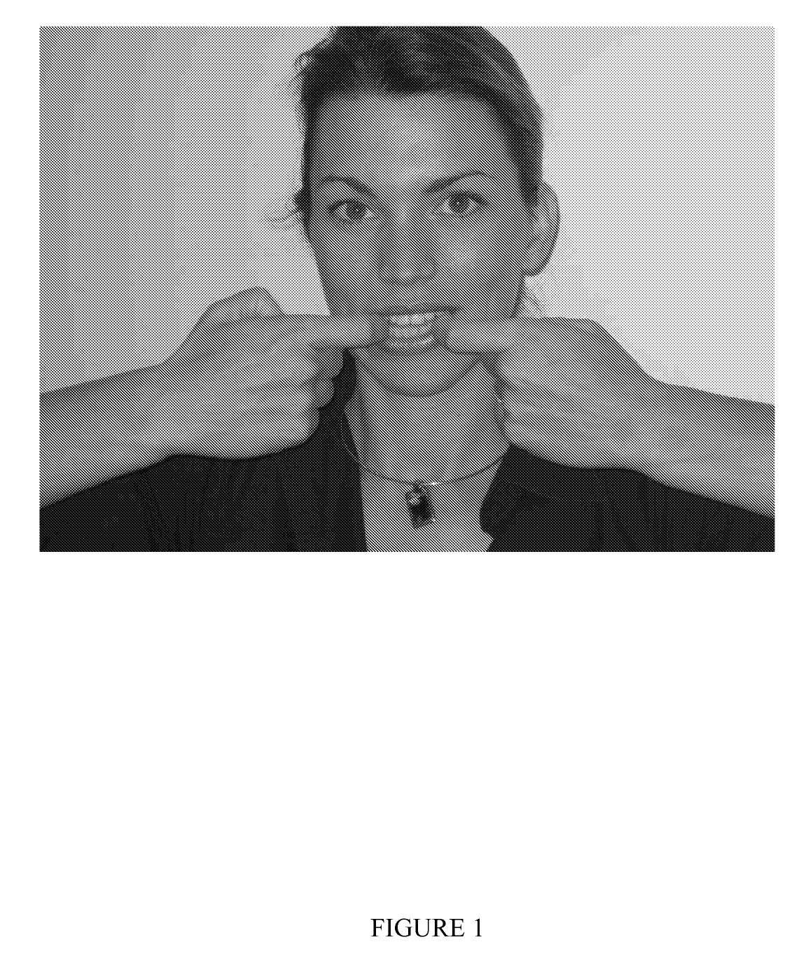

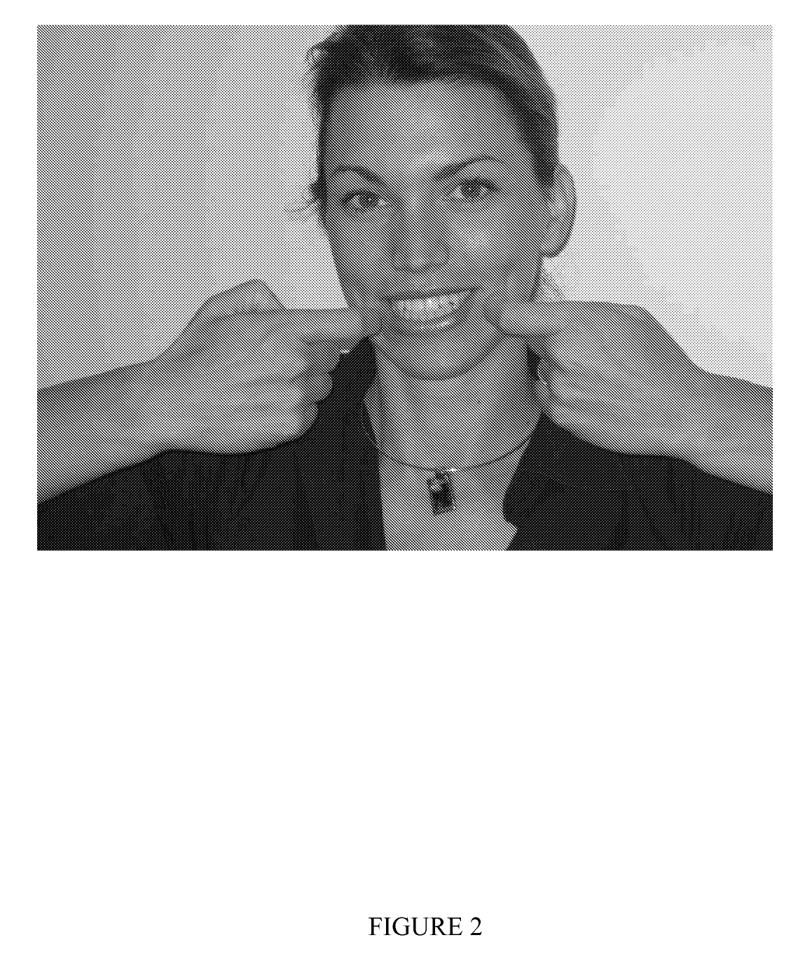

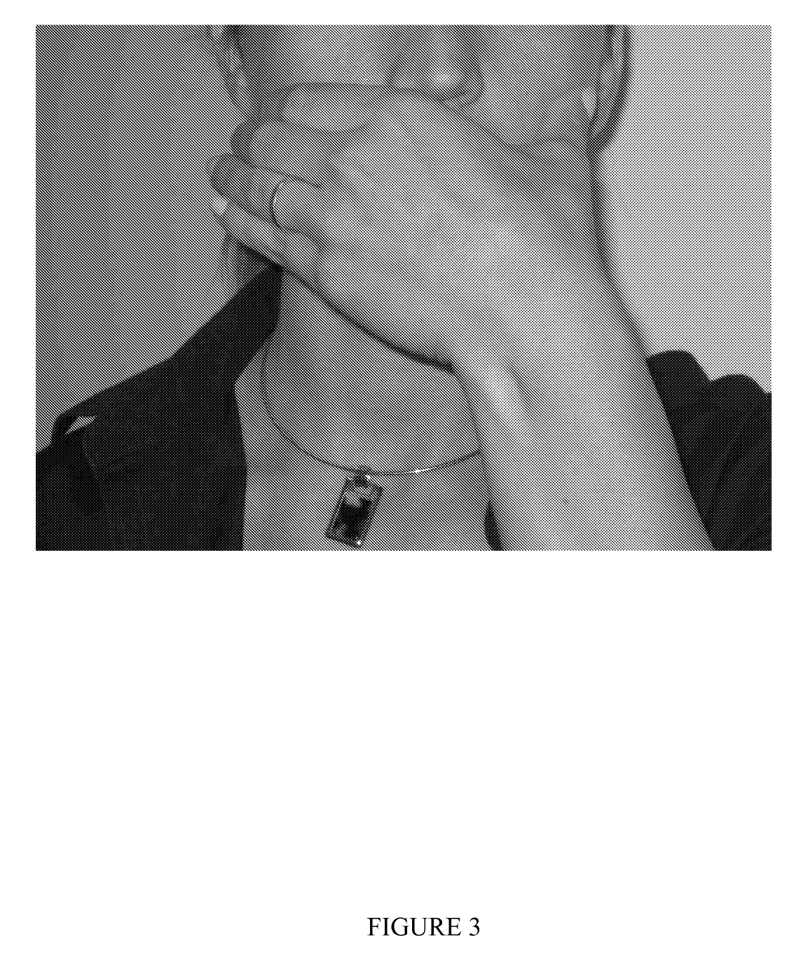

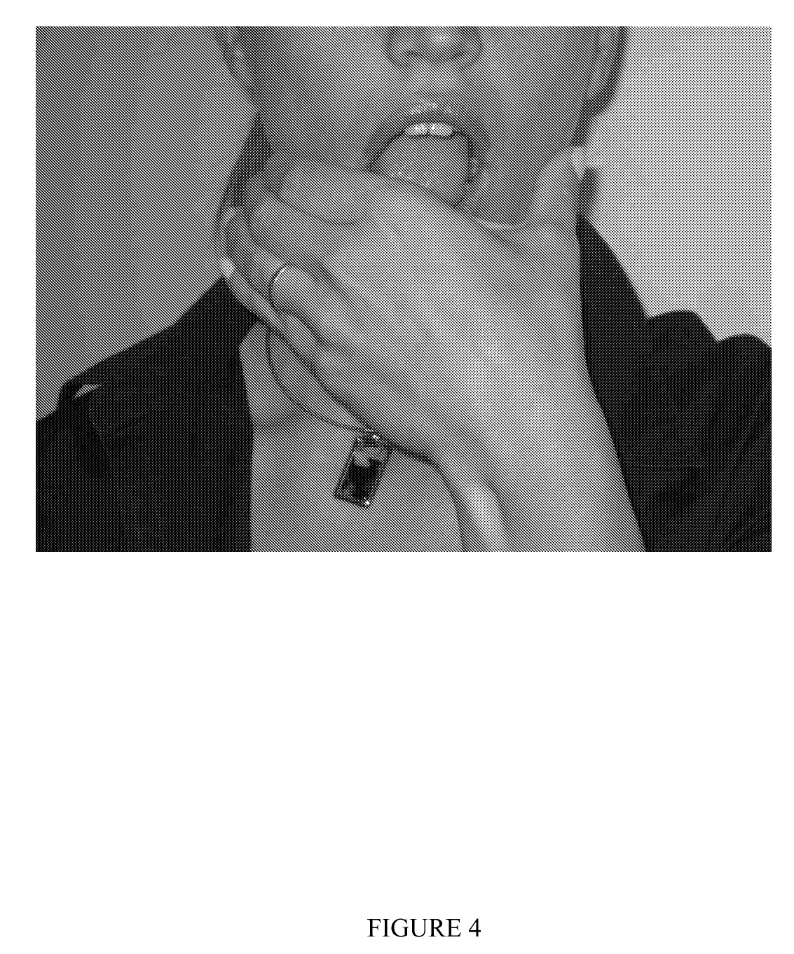

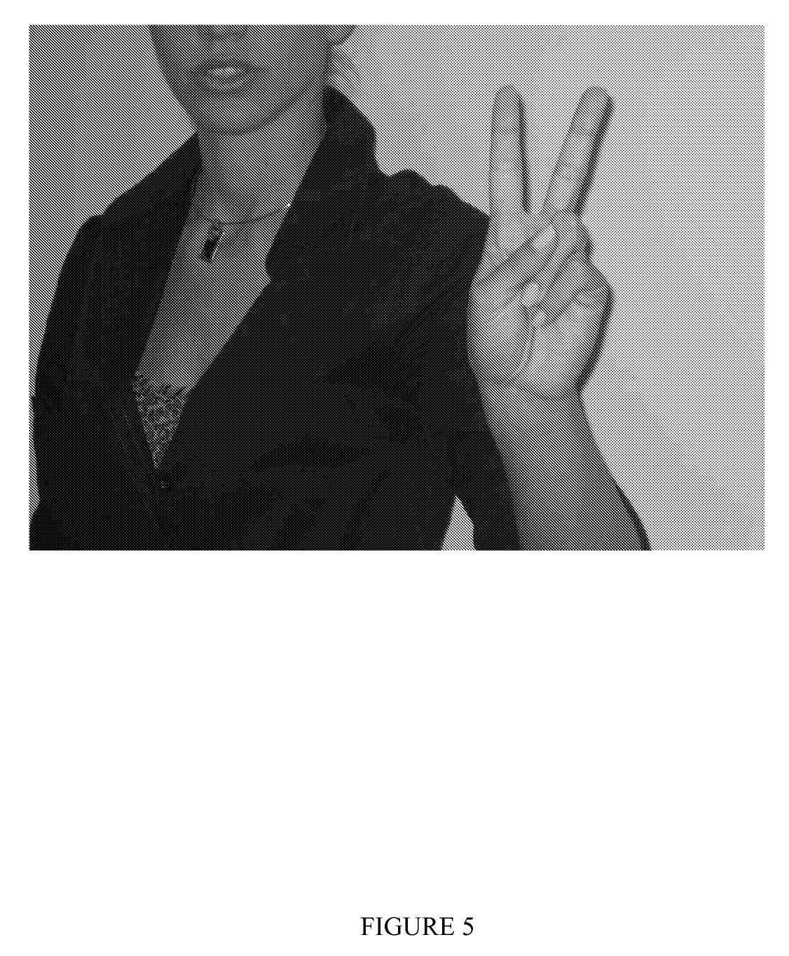

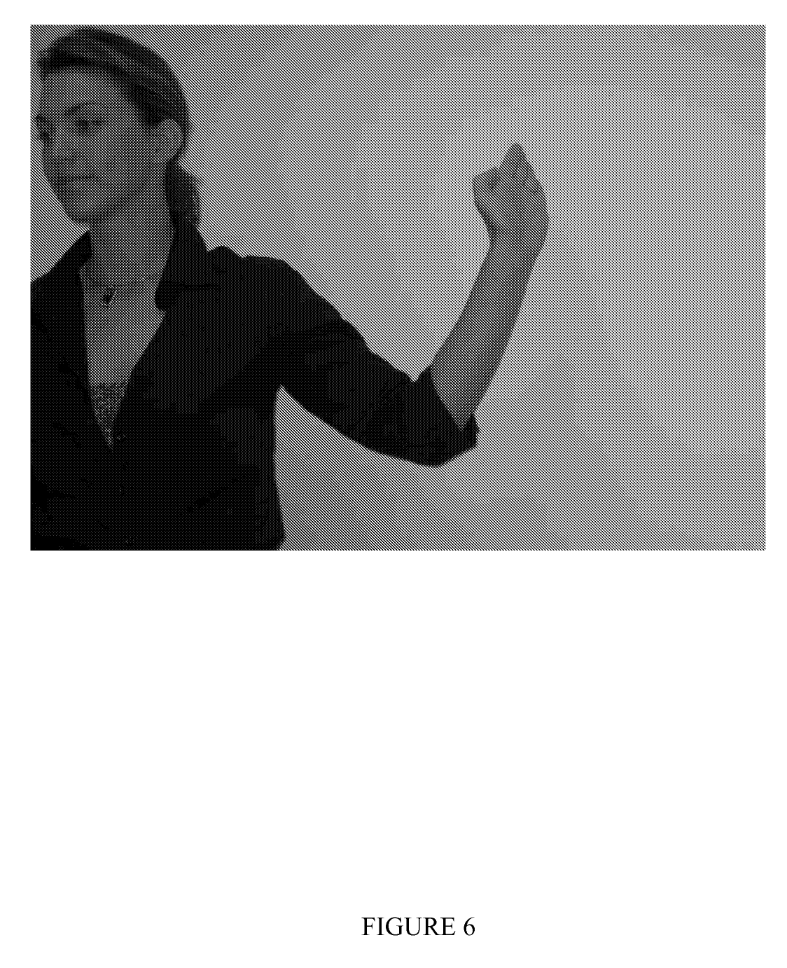

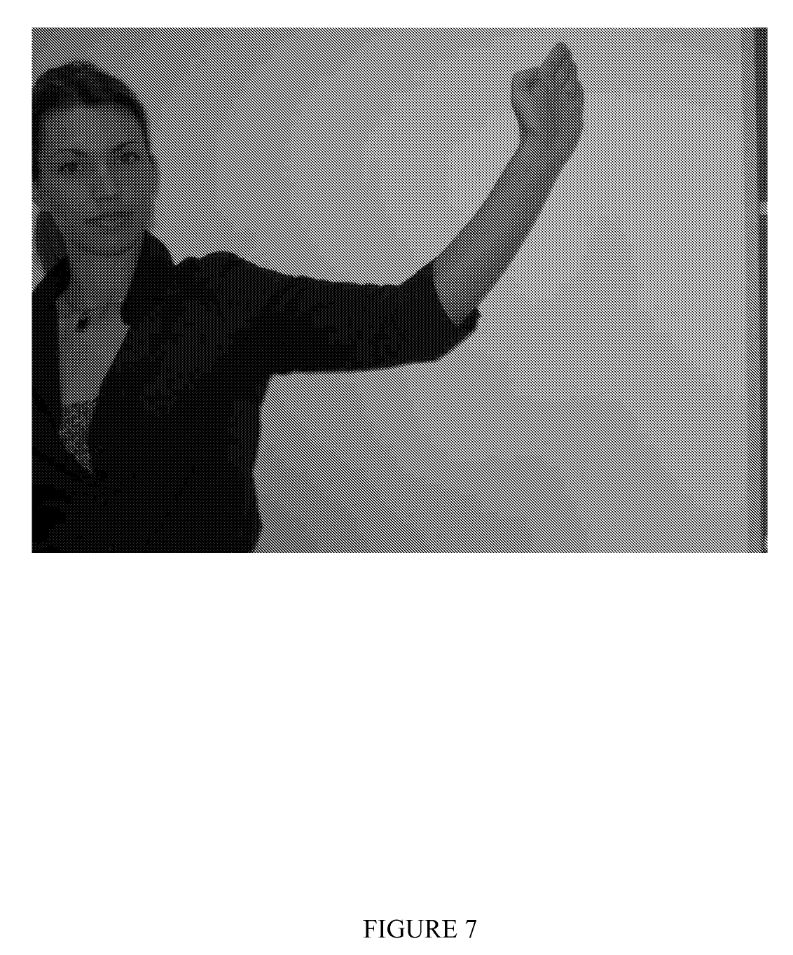

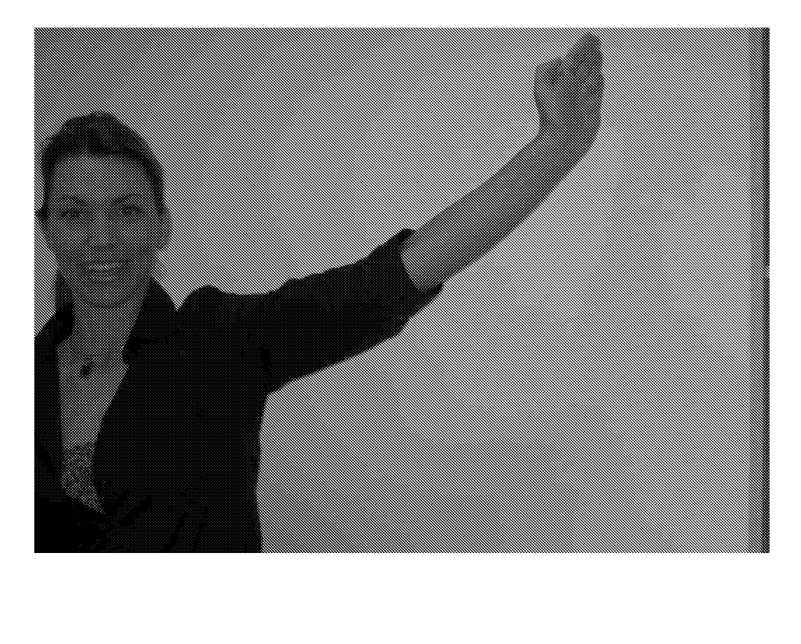

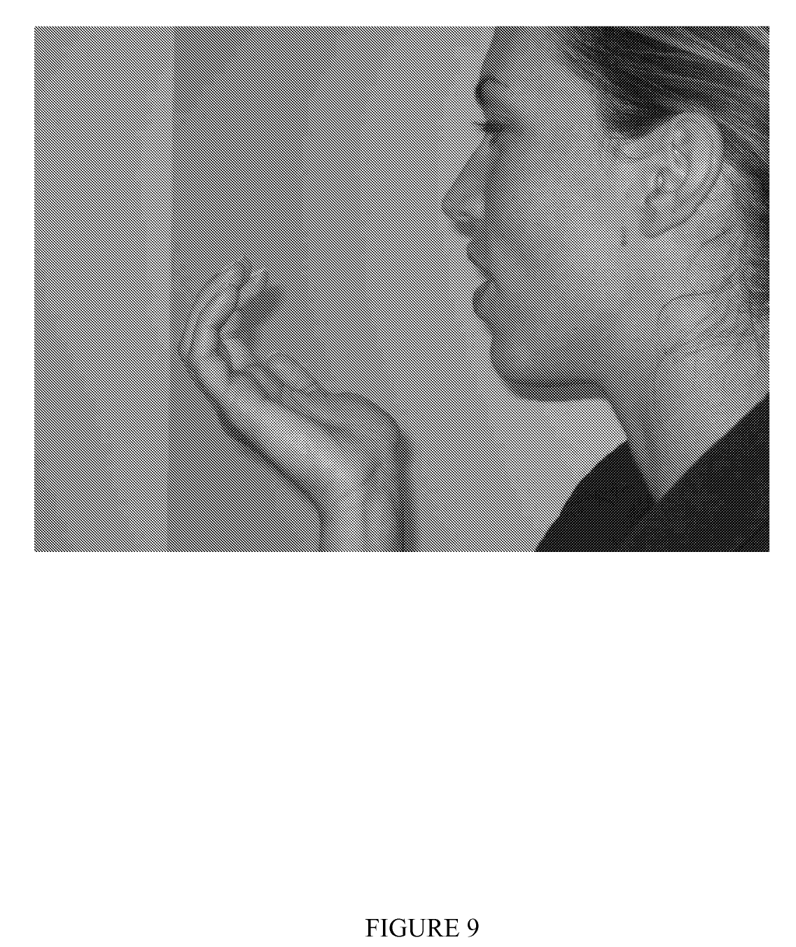

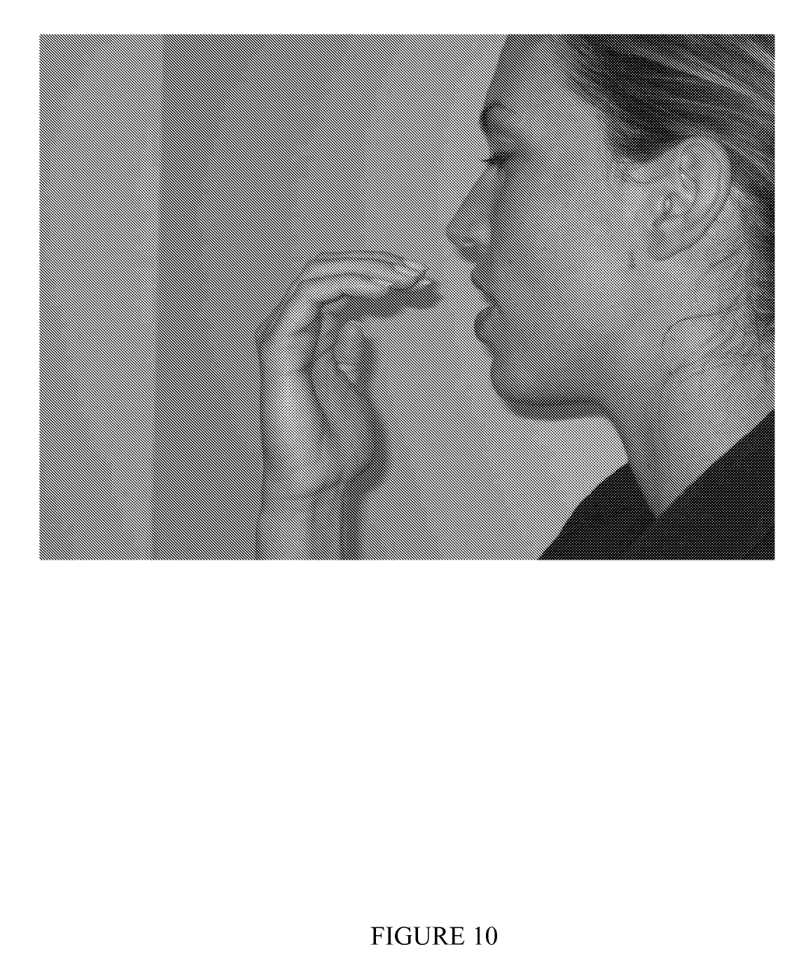

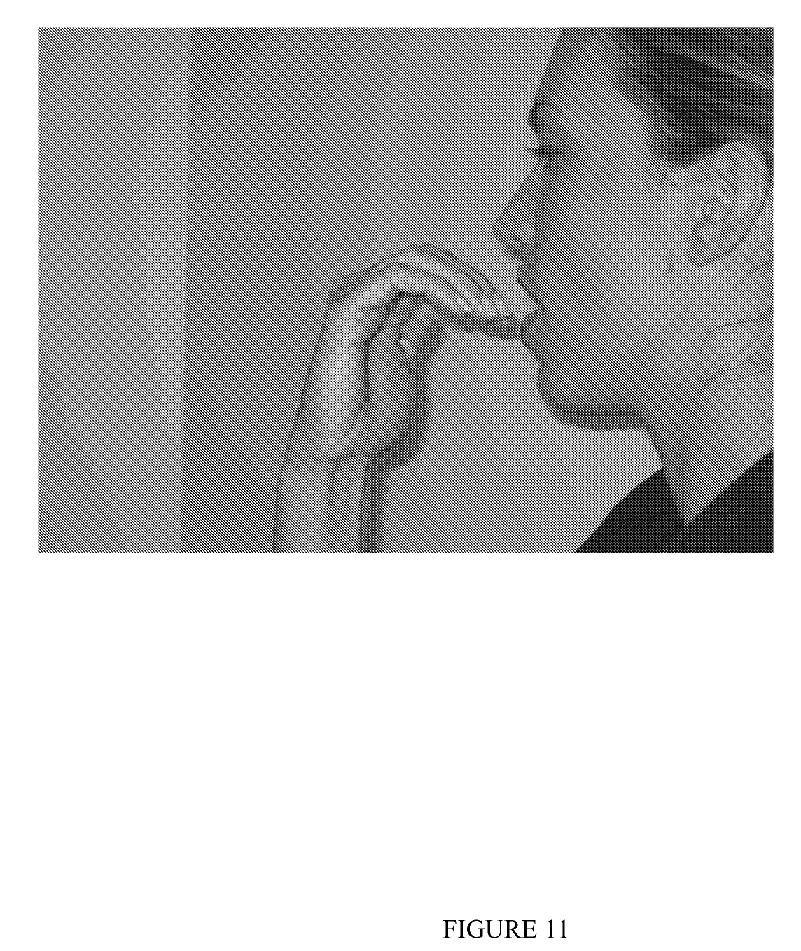

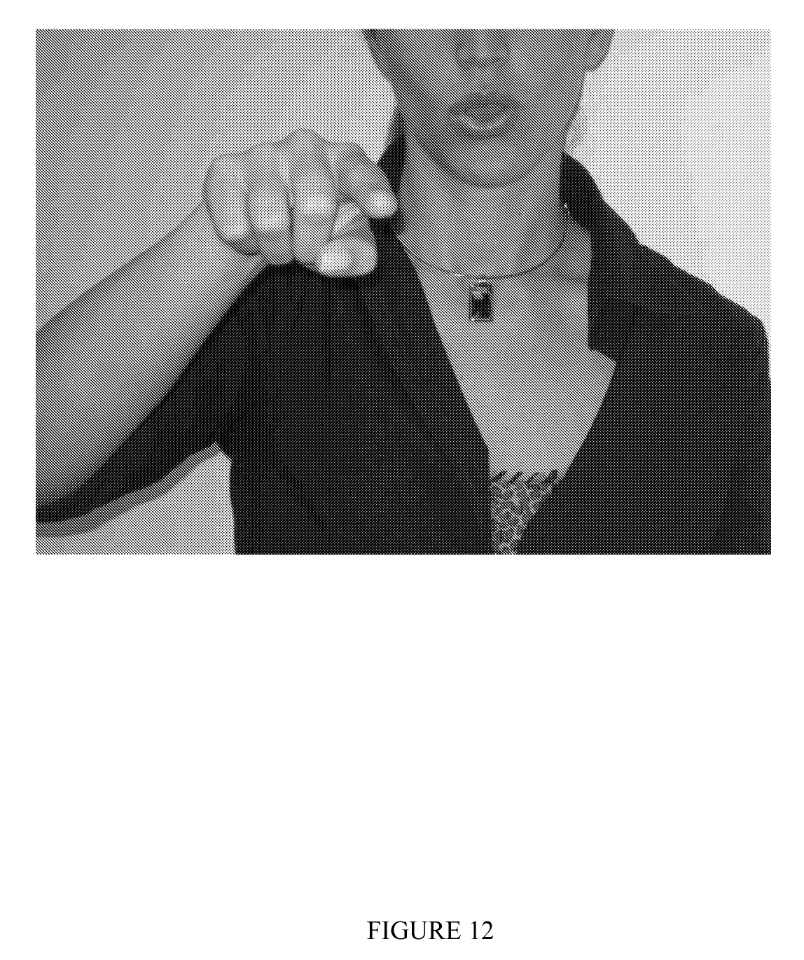

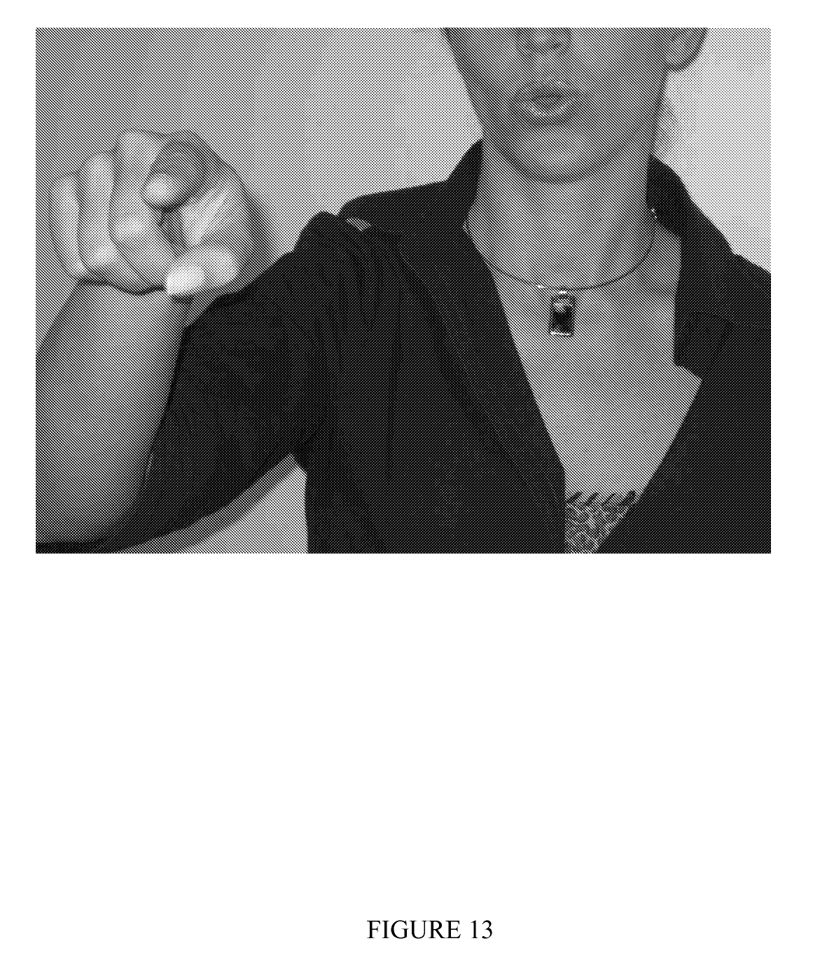

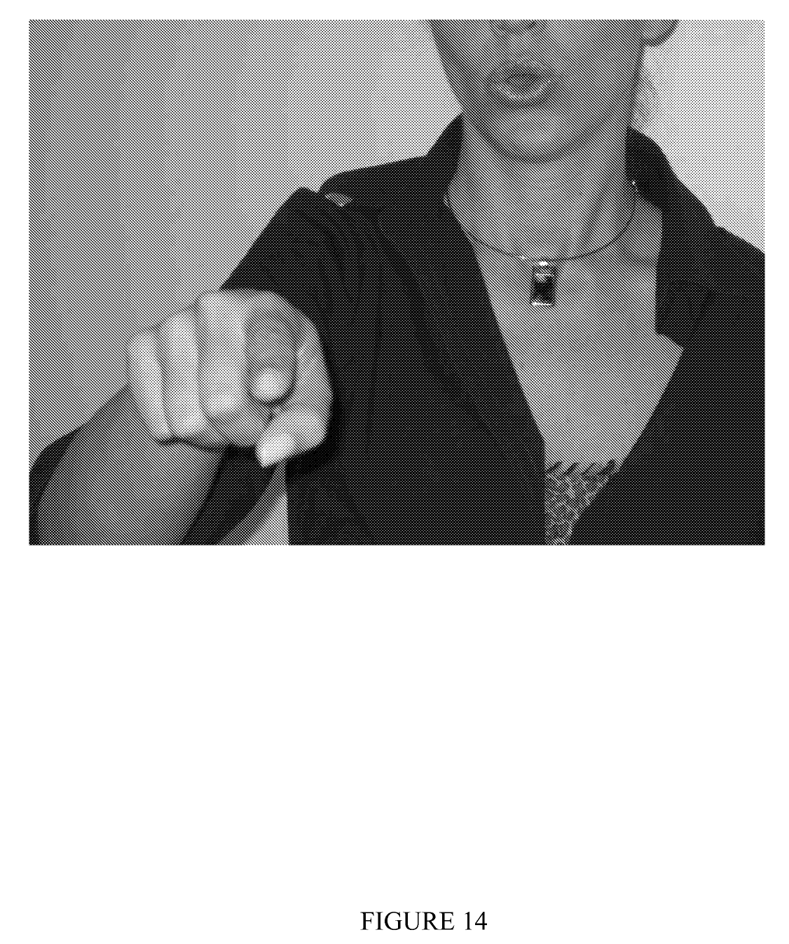

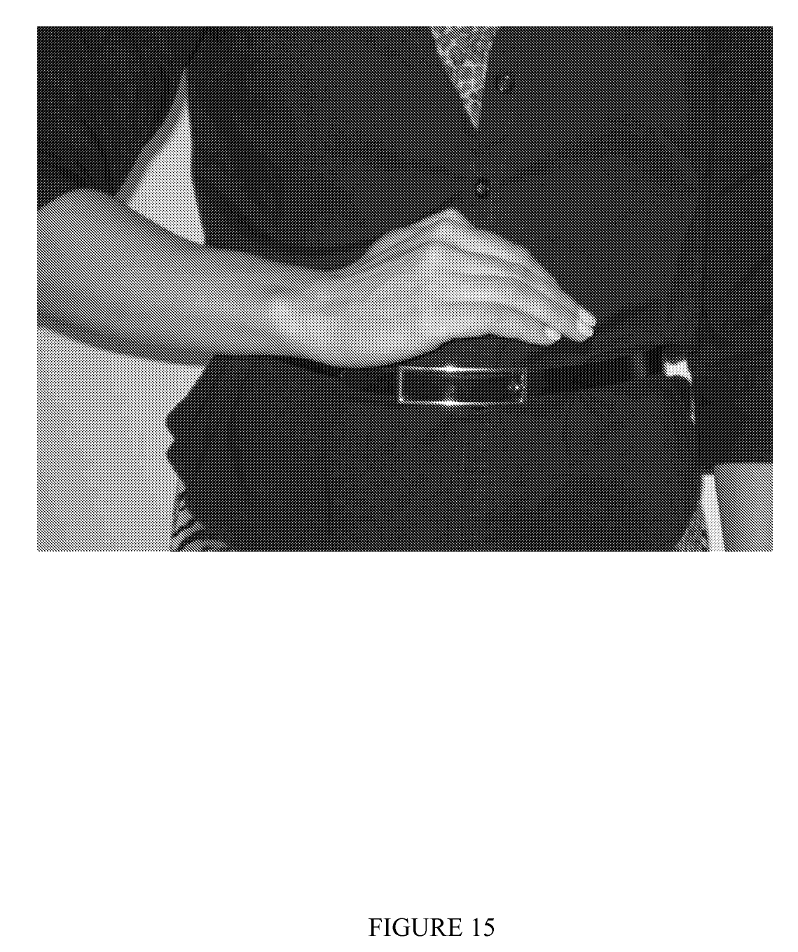

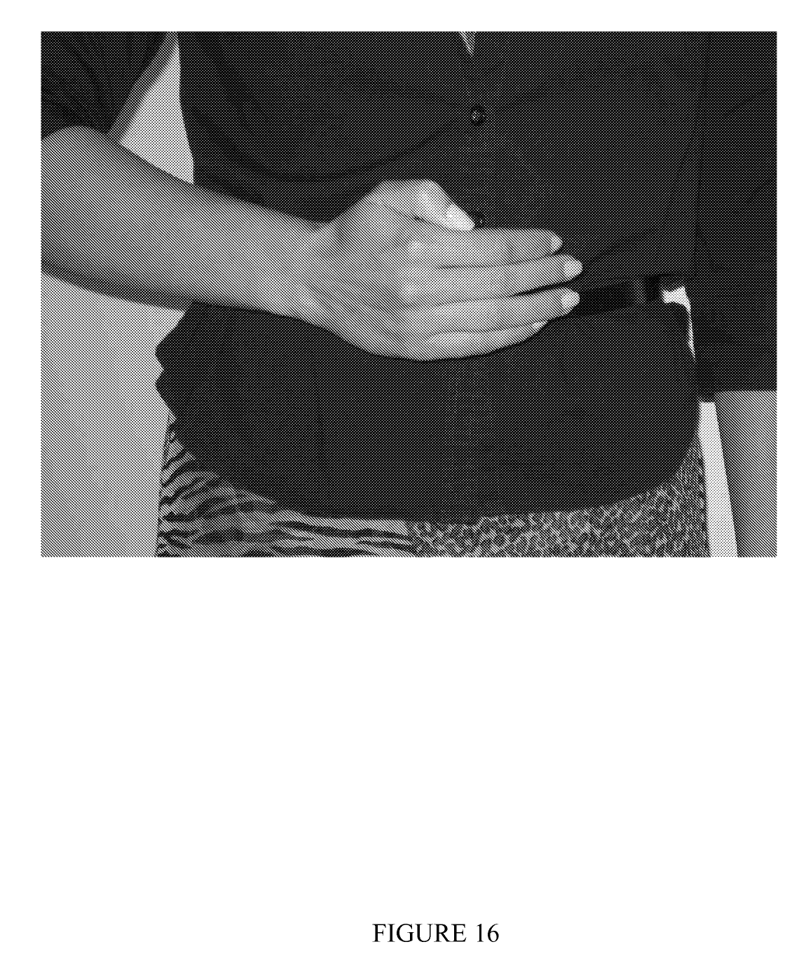

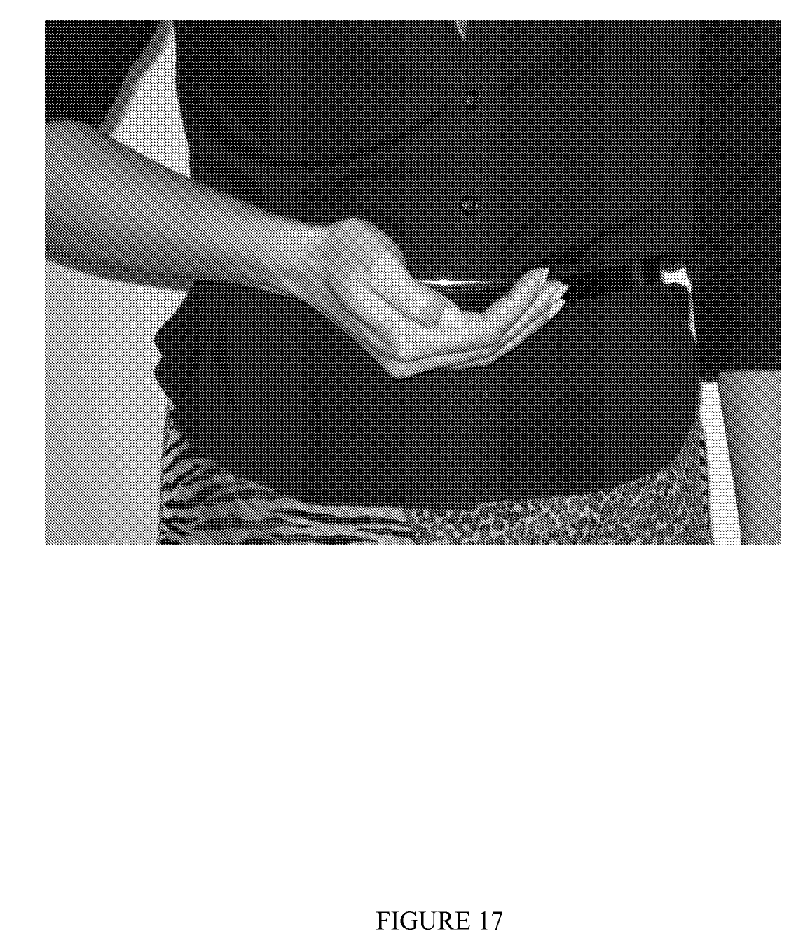

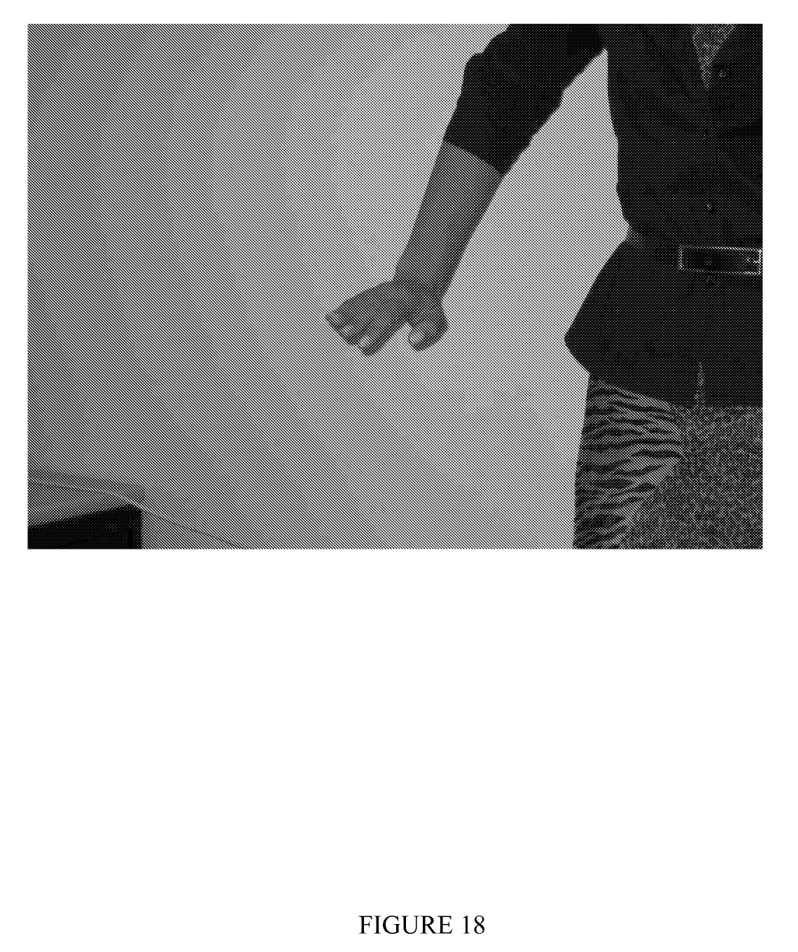

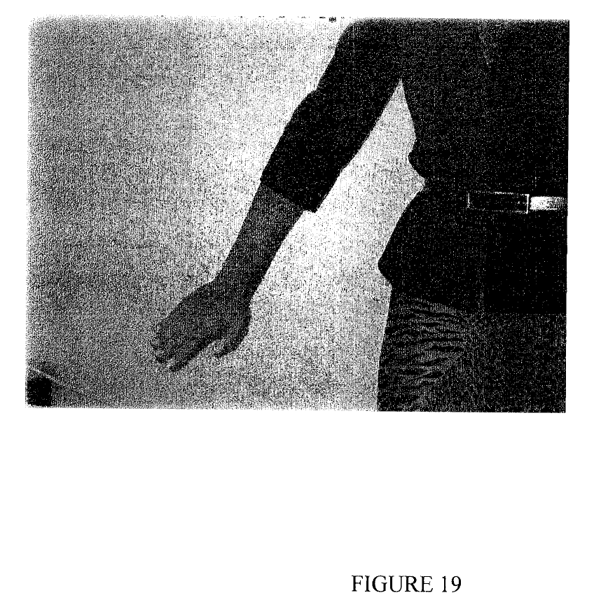

The method may consist of the steps of: associating a hand gesture with the sound; associating a movement of the hand gesture with variations in the sound to provide a sound gesture; identifying a mouth movement; associating a hand gesture with the mouth movement; associating a movement of the hand gesture with the mouth movement to provide a mouth gesture; identifying a phonetic articulation; associating a hand gesture with the phonetic articulation; associating a movement of the hand gesture with the phonetic articulation to provide a phonetic gesture. FIGS. 1-20 depict hand gestures and mouth movements. As shown in FIGS. 1-2, this is the AE sound. To make this sound, lower your jaw, slightly tense your lips and form a wide, downward smile. This sound is shown generally by the instructor making the half-smile, with the index finger extending the mouth. Word Examples: and, animal, stand, language, happen, family, fraction, perhaps, again, says, glad, dad and bury. FIGS. 3-4 depicts hand gestures that may be associated with the AH sound. To make this vowel sound, drop your jaw, slightly tense your lips and round them forward halfway. The hand motion for this sound is both hands below the mouth, sideways curled, and moving downwards, signifying the dropping the jaw motion. Double time word length indicated by two fingers forming a V shape. FIG. 5 depicts the hand gesture that may be associated with DOUBLE TIME. This is to signify that the sound is extended and/or emphasized. The hand motion for this sound is two fingers extended to make a V shape. FIGS. 6-8 depicts the hand gesture that may be associated with the EE sound. To make this sound, set your lips ⅜″ apart. Widen your lips into a big smile. The sound is long. Count to two silently to be sure it is long enough. This sound is shown by the left hand pressing in the upper left direction, to signify stretching out the sound. The “y” and “ee” are expressed by opposite hands, going in the opposite direction, to signify the sounds being opposite to each other. The student will easily identify the difference and which sound they should use for the particular part of the word, to practice the contrast. Word examples: Key, ski, beet, seat, freeze, scene, three, heat, melody, region, believe, dictionary, especially and degree. FIGS. 9-11 depicts the hand gesture that may be associated with the ER sound. To make this sound, keep the upper and lower teeth apart, and roll back your tongue without touching the inside of your mouth. There are no mouth movements. This sound is shown by the right hand, palm facing inward, fingers curled inside next to the instructor's mouth, to signify the curling of your tongue inside your mouth. Word Examples: word, picture, water, operate, dollar, require, corner, sister, burn, particular, occur, nature and shoulder. FIGS. 12-14 depicts the hand gesture that may be associated with the O sound. To make this sound, keep your mouth slightly open, and you're your lips into a circle. As you are making the sound, you will move your lips into a smaller circle. This sound is expressed by the right index finger making a circular motion. Length of the sound is shown with “double time” hand motion, which is represented by a V sign formed with two fingers. FIG. 15-17 depicts the hand gestures that may be associated with the UGH sound. To make this sound, keep your lips slightly apart and make a short sound. This sound is shown by the right hand facing down, curled inward near the abdomen area, to signify that the sound should occur inside your stomach. Word Examples: cousin, just, under, mother, country, sudden, art, son, brother, sharp, wash, agree, nothing, drop, arm, wonder and drop. FIGS. 18-19 depicts the hand gestures that may be associated with the Y sound. To make this sound, lower your jaw slightly. The lips are relaxed and are about ¼″ apart. The sound is short. This sound is shown by the right hand pressing down to the lower right hand direction. The right hand is fully open, and facing down to express the suppressing action that takes place in the abdomen, to produce this sound. Word Examples: Gym, pretty, picture, mountain, certain, office, submission, indicate, history, basic, solution, syllable, believe, window, wish winter, English, busy, trip and represent.

According to one embodiment of the present invention a method of teaching language instruction is provided, the method comprising the steps of: identifying a sound, where the sound is a portion of a word; associating a hand gesture with the sound; associating a movement of the hand gesture with variations in the sound to provide a sound gesture; providing a portion of text to be read by a user; correcting the users pronunciation utilizing the sound gesture. The sound may be selected from the group consisting of y, u, o, all, er, ch, s, z and th. The hand gesture is selected from the group consisting of pointing, circular motion, upward/downward motion, and side to side motion.

The method as in the present invention may further comprise the steps of: identifying a mouth movement; associating a hand gesture with the mouth movement; associating a movement of the hand gesture with the mouth movement to provide a mouth gesture; providing a portion of text to be read by a user; correcting the users mouth movement utilizing the mouth gesture.

The method may further comprise the steps of: identifying a phonetic articulation; associating a hand gesture with the phonetic articulation; associating a movement of the hand gesture with the phonetic articulation to provide a phonetic gesture; providing a portion of text to be read by a user; correcting the phonetic articulation utilizing the phonetic gesture. In certain instances, there may be the additional step of: associating a complex sound with a specific gesture.

According to another embodiment of the present invention, a method of evaluating and correcting language instruction is disclosed, the method comprising the steps of: providing a reading sample for a student; asking the student to read the reading sample aloud; assessing the students ability to pronounce the y sound versus the ee sound and providing a relative score according to the students pronunciation of the y sound; assessing the students ability to pronounce the er sound and providing a relative score according to the students pronunciation of the er sound; assessing the students ability to pronounce the ah sound and providing a relative score according to the students pronunciation of the ah sound; assessing the students ability to pronounce the ae sound and providing a relative score according to the students pronunciation of the ae sound; assessing the students ability to pronounce the o sound and providing a relative score according to the students pronunciation of the o; assessing the students ability to pronounce the th sound and providing a relative score according to the students pronunciation of the th sound; assessing the students ability to pronounce a ugh sound and providing a relative score according to the students pronunciation of the ugh sound; assessing the students ability to pronounce a ch sound versus a j sound and providing a relative score according to the students pronunciation of the ch sound versus the j sound; assessing the students ability to pronounce a w sound versus a v sound and providing a relative score according to the students pronunciation of the w sound versus the v sound; assessing the students ability to pronounce a oogh sound and providing a relative score according to the students pronunciation of the oogh sound; assessing the students ability to pronounce an s sound versus a z sound and providing a relative score according to the students pronunciation of the s sound versus the z sound; and determining a lesson plan according to the relative scores.

The step of assessing a students ability to pronounce certain sounds may be done through an assessment test that consists of sentences with words and word groups with the specific sounds distributed throughout the sentence. The evaluator, carefully listening to the student's pronunciation to see if the sound exists or not, will put a point value for each category. After going over the sentence reading exercises, the evaluator will add up the points, and come up with the point value, that will help determine the student's starting point, and how many lessons will be recommended for the individual. Please see the following evaluation (assessment) test.

### Pronunciation

### Y Vs. EE

### “The Business is Open at this Typical Location.”

1. Does “business” clearly have two “Y” sounds?
2. Does the “-EN” in open sound like “-IN”?
3. Does the “-ION” in “location” sound like “-IN”?

### “This is Only the Beginning of Your English Program.”

4. Does “this” have a clear “Y” sound?
5. Do both “I”s in “beginning” sound like “Y”?
6. Does “English” have two clear “Y” sounds?

### “He's Been Living Here for Fifteen Years.”

7. Is there a clear distinction between “EE” and “Y”?
8. Do “here” and “years” have the same “EAR” sound?
9. Do “he” and “been” have clear “EE” sounds?
10. Do the “I”s in “living” and “fifteen” are clear “Y” sounds (and not “EE”)?

### “The Father and the Mother Never Work Together with the Girl in the Center.”

11. Do the ending “-ER”s in all sound the same?
12. Do both “work” and “girl” sound clear?

### “Her Sister is Certain that Mr. Burr was Wearing a Fake and not Fur.”

13. Do all the “-ER”s sound clear?
14. Does the “-UR” in “Burr” and “fur” sound like “ER”?

### “The Measured Temperature of this Natural Surface has Clearly Broken the World Record.”

15. Do all “ER”s sound the same?
16. Are the “ER” sounds in “world” and “record” clear?

The evaluator may provide a relative score according to the students responses to such questions.

The method may further comprise the steps of: identifying a sound, where the sound is a portion of a word; associating a hand gesture with the sound; associating a movement of the hand gesture with variations in the sound to provide a sound gesture; identifying a mouth movement; associating a hand gesture with the mouth movement; associating a movement of the hand gesture with the mouth movement to provide a mouth gesture; identifying a phonetic articulation; associating a hand gesture with the phonetic articulation; associating a movement of the hand gesture with the phonetic articulation to provide a phonetic gesture; providing a portion of text to be read by a user; correcting the users pronunciation utilizing the sound gesture; correcting the users mouth movement utilizing the mouth gesture; and correcting the phonetic articulation utilizing the phonetic gesture. The hand gesture may be selected from the group consisting of pointing, circular motion, upward/downward motion, and side to side motion. The method may also comprise the step of associating a complex sound with a specific gesture.

The present invention also provides a method of evaluating and correcting language instruction, the method comprising the steps of: providing a reading sample for a student; asking the student to read the reading sample aloud; assessing the students ability to pronounce the y sound versus the ee sound and providing a relative score according to the students pronunciation of the y sound; assessing the students ability to pronounce the er sound and providing a relative score according to the students pronunciation of the er sound; assessing the students ability to pronounce the ah sound and providing a relative score according to the students pronunciation of the ah sound; assessing the students ability to pronounce the ae sound and providing a relative score according to the students pronunciation of the ae sound; assessing the students ability to pronounce the o sound and providing a relative score according to the students pronunciation of the o; assessing the students ability to pronounce the th sound and providing a relative score according to the students pronunciation of the th sound; assessing the students ability to pronounce a ugh sound and providing a relative score according to the students pronunciation of the ugh sound; assessing the students ability to pronounce a ch sound versus a j sound and providing a relative score according to the students pronunciation of the ch sound versus the j sound; assessing the students ability to pronounce a w sound versus a v sound and providing a relative score according to the students pronunciation of the w sound versus the v sound; assessing the students ability to pronounce a oogh sound and providing a relative score according to the students pronunciation of the oogh sound; assessing the students ability to pronounce an s sound versus a z sound and providing a relative score according to the students pronunciation of the s sound versus the z sound; determining a lesson plan according to the relative scores and working on those sounds have the lowest relative scores; identifying a sound, where the sound is a portion of a word; associating a hand gesture with the sound; associating a movement of the hand gesture with variations in the sound to provide a sound gesture; identifying a mouth movement; associating a hand gesture with the mouth movement; associating a movement of the hand gesture with the mouth movement to provide a mouth gesture; identifying a phonetic articulation; associating a hand gesture with the phonetic articulation; associating a movement of the hand gesture with the phonetic articulation to provide a phonetic gesture; providing a portion of text to be read by a user; correcting the users pronunciation utilizing the sound gesture; correcting the users mouth movement utilizing the mouth gesture; and correcting the phonetic articulation utilizing the phonetic gesture.

It should be understood that the foregoing relates to preferred embodiments of the invention and that modifications may be made without departing from the spirit and scope of the invention as set forth in the following claims.

I claim:

1. A method of teaching language instruction, said method comprising the steps of:
identifying a sound, where said sound is a portion of a word;
associating a hand gesture with said sound;
associating a movement of said hand gesture with variations in said sound to provide a sound gesture;
providing a portion of text to be read by a user;
correcting said users pronunciation utilizing said sound gesture.

2. A method as in claim 1, further comprising the steps of:
identifying a mouth movement;
associating a hand gesture with said mouth movement;
associating a movement of said hand gesture with said mouth movement to provide a mouth gesture;
providing a portion of text to be read by a user;
correcting said users mouth movement utilizing said mouth gesture.

3. A method as in claim 1, further comprising the steps of:
identifying a phonetic articulation;
associating a hand gesture with said phonetic articulation;
associating a movement of said hand gesture with said phonetic articulation to provide a phonetic gesture;
providing a portion of text to be read by a user;
correcting said phonetic articulation utilizing said phonetic gesture.

4. A method as in claim 1, wherein said sound is selected from the group consisting of y, u, o, all, er, ch, s, z and th.

5. A method as in claim 1, wherein said hand gesture is selected from the group consisting of pointing, circular motion, upward/downward motion, and side to side motion.

6. A method as in claim 1, further comprising the step of:
associating a complex sound with a specific gesture.

7. A method of evaluating and correcting language instruction, said method comprising the steps of:
Providing a reading sample for a student;
asking said student to read said reading sample aloud;
assessing said students ability to pronounce the y sound versus the ee sound and providing a relative score according to said students pronunciation of said y sound;
assessing said students ability to pronounce the er sound and providing a relative score according to said students pronunciation of said er sound;
assessing said students ability to pronounce the ah sound and providing a relative score according to said students pronunciation of said ah sound;
assessing said students ability to pronounce the ae sound and providing a relative score according to said students pronunciation of said ae sound;
assessing said students ability to pronounce the o sound and providing a relative score according to said students pronunciation of said o;
assessing said students ability to pronounce the th sound and providing a relative score according to said students pronunciation of said th sound;
assessing said students ability to pronounce a ugh sound and providing a relative score according to said students pronunciation of said ugh sound;
assessing said students ability to pronounce a ch sound versus a j sound and providing a relative score according to said students pronunciation of said ch sound versus said j sound;
assessing said students ability to pronounce a w sound versus a v sound and providing a relative score according to said students pronunciation of said w sound versus said v sound;
assessing said students ability to pronounce a oogh sound and providing a relative score according to said students pronunciation of said oogh sound;
assessing said students ability to pronounce an s sound versus a z sound and providing a relative score according to said students pronunciation of said s sound versus said z sound; and
determining a lesson plan according to said relative scores.

8. A method as in claim 7, further comprising the steps of:
identifying a sound, where said sound is a portion of a word;
associating a hand gesture with said sound;
associating a movement of said hand gesture with variations in said sound to provide a sound gesture;
identifying a mouth movement;
associating a hand gesture with said mouth movement;
associating a movement of said hand gesture with said mouth movement to provide a mouth gesture;
identifying a phonetic articulation;
associating a hand gesture with said phonetic articulation;
associating a movement of said hand gesture with said phonetic articulation to provide a phonetic gesture;
providing a portion of text to be read by a user;
correcting said users pronunciation utilizing said sound gesture;
correcting said users mouth movement utilizing said mouth gesture; and
correcting said phonetic articulation utilizing said phonetic gesture.

9. A method as in claim 8, wherein said hand gesture is selected from the group consisting of pointing, circular motion, upward/downward motion, and side to side motion.

10. A method as in claim 8, further comprising the step of:
associating a complex sound with a specific gesture.

11. A method of evaluating and correcting language instruction, said method comprising the steps of:
Providing a reading sample for a student;
asking said student to read said reading sample aloud;
assessing said students ability to pronounce the y sound versus the ee sound and providing a relative score according to said students pronunciation of said y sound;
assessing said students ability to pronounce the er sound and providing a relative score according to said students pronunciation of said er sound;
assessing said students ability to pronounce the ah sound and providing a relative score according to said students pronunciation of said ah sound;
assessing said students ability to pronounce the ae sound and providing a relative score according to said students pronunciation of said ae sound;
assessing said students ability to pronounce the o sound and providing a relative score according to said students pronunciation of said o;
assessing said students ability to pronounce the th sound and providing a relative score according to said students pronunciation of said th sound;
assessing said students ability to pronounce a ugh sound and providing a relative score according to said students pronunciation of said ugh sound;
assessing said students ability to pronounce a ch sound versus a j sound and providing a relative score according to said students pronunciation of said ch sound versus said j sound;
assessing said students ability to pronounce a w sound versus a v sound and providing a relative score according to said students pronunciation of said w sound versus said v sound;
assessing said students ability to pronounce a oogh sound and providing a relative score according to said students pronunciation of said oogh sound;
assessing said students ability to pronounce an s sound versus a z sound and providing a relative score according to said students pronunciation of said s sound versus said z sound;
determining a lesson plan according to said relative scores and working on those sounds have the lowest relative scores;
identifying a sound, where said sound is a portion of a word;
associating a hand gesture with said sound;
associating a movement of said hand gesture with variations in said sound to provide a sound gesture;
identifying a mouth movement;
associating a hand gesture with said mouth movement;
associating a movement of said hand gesture with said mouth movement to provide a mouth gesture;
identifying a phonetic articulation;
associating a hand gesture with said phonetic articulation;
associating a movement of said hand gesture with said phonetic articulation to provide a phonetic gesture;
providing a portion of text to be read by a user;
correcting said users pronunciation utilizing said sound gesture;
correcting said users mouth movement utilizing said mouth gesture; and
correcting said phonetic articulation utilizing said phonetic gesture.

12. A method as in claim 11, wherein said hand gesture is selected from the group consisting of pointing, circular motion, upward/downward motion, and side to side motion.

13. A method as in claim 11, further comprising the step of:
associating a complex sound with a specific gesture.
